(19) United States
(12) Patent Application Publication
(10) Pub. No.: US 2023/0391631 A1
(43) Pub. Date: Dec. 7, 2023

(54) METAL CATIONS AS INORGANIC STRUCTURE DIRECTING AGENTS DURING THE SYNTHESIS OF PHILLIPSITE AND TOBERMORITE

(71) Applicant: The Regents of the University Of California, Oakland, CA (US)

(72) Inventors: Dante Simonetti, Los Angeles, CA (US); Juan Carlos Vega-Vila, Los Angeles, CA (US); Gaurav Sant, Los Angeles, CA (US); Advait Holkar, Los Angeles, CA (US); Samanvaya Srivastava, Los Angeles, CA (US); Ross Arnold, Los Angeles, CA (US)

(21) Appl. No.: 18/200,875

(22) Filed: May 23, 2023

Related U.S. Application Data
(60) Provisional application No. 63/344,789, filed on May 23, 2022.

(51) Int. Cl. C01B 39/28; C01B 39/46

(52) U.S. Cl. CPC C01B 39/28; C01B 39/46; C01P 2004/04; C01P 2002/72; C01P 2002/77; C01P 2006/14

(57) ABSTRACT

The present disclosure relates to zeolites comprising Al, Si, O, H, Na, K and Ca, wherein the zeolite advantageously comprises phillipsite and tobermorite phases. The present disclosure further provides methods of preparing the zeolites from a synthesis gel.

### CROSS-REFERENCE TO RELATED APPLICATIONS

This application claims the benefit of priority to U.S. Provisional Patent Application No. 63/344,789, filed May 23, 2022, the contents of which are hereby incorporated by reference in their entirety.

### STATEMENT REGARDING FEDERALLY SPONSORED RESEARCH

This invention was made with government support under Grant Number DE-AR0001147, awarded by the Department of Energy. The government has certain rights in the invention.

### BACKGROUND

Structurally defined materials impart varying stages of complexity and functionality to inorganic solids. The addition of porous structures, as in the case of zeolitic materials, provide the capabilities to perform adsorption processes¹ and contribute favorable reaction cavities for catalytic chemical transformations.² It is therefore of general interest to control the structure and size of the porous cavities, largely targeted by judicious choices of synthesis conditions and parameters. The present disclosure provides zeolites and methods of preparing them which address these needs.

### SUMMARY OF THE INVENTION

The present disclosure provides in some embodiments, a zeolite having a micropore volume from about 0.001 to about 0.1 cm³/g, comprising Al, Si, O, H, Na, K and Ca; wherein the zeolite comprises:
a total cation content:aluminum ratio (Cat:Al) from about 0.4 to about 40, defined by

((K+Na+Ca)/(Al)) (I);
a sodium:aluminum ratio (Na:Al) of from about 0.1 to about 16;
a potassium:aluminum ratio (K/Al) of from about 0.01 to about 15; and
a calcium:aluminum ratio (Ca/Al) of from about 0.001 to about 10.

In certain embodiments, the present disclosure provides a method of preparing a zeolite the method comprising:
preparing a synthesis gel, the synthesis gel comprising
   aNa₂O:bK₂O:cCaO:dAl₂O₃:eSiO₂:fH₂O, wherein
a is from about 0.01 to about 5,
b is from about 0.01 to about 1,
c is from about 0.01 to about 2,
d is from about 0.01 to about 0.5,
e is from about 0.1 to about 2,
f is from 10 to about 50; and
further wherein the fraction of calcium in the total cationic content of the synthesis gel is represented by a charge ratio (R_{C}), wherein R_{C} is described by formula II:

(2x)/(y+z+(2x))=R_{C} (II);
wherein x represents the number of calcium cations present in the synthesis gel;
y represents the number of potassium cations present in the synthesis gel;
z represents the number of sodium cations present in the synthesis gel; and
R_{C} is between 0 and 1;
   aging the synthesis gel;
   heating the synthesis gel to produce a product mixture; and
   collecting the zeolite from the product mixture.

### BRIEF DESCRIPTION OF THE DRAWINGS

FIG. 1 is a plot showing X-Ray Diffraction (XRD) patterns of (a) PHI-TOB-373-0, (b) PHI-TOB-373-0.25, (c) PHI-TOB-373-0.50, (d) PHI-TOB-373-0.75, and (e) PHI-TOB-373-1 crystallized at (A) 373 K, and of (a) PHI-TOB-393-0, (b) PHI-TOB-393-0.30, (c) PHI-TOB-393-0.50, (d) PHI-TOB-393-0.80, and (e) PHI-TOB-393-1 crystallized at (B) 393 K.

FIG. 2 is a plot of Micropore volume (cm³ g⁻¹) of PHI-TOB-373 (▪) and PHI-TOB-393 (●), plotted with respect to the silicon concentration in the synthesis gel.

FIG. 3 is an illustration of the porous cavities of phillipsite zeolites after heat treatments at 373 or 393 K (168 h) prior and after water washing steps and drying procedures (363 K, 16 h).

FIG. 4 is a plot displaying potassium and sodium content normalized by the aluminum content in the recovered solids with varying the total charge ratio in hydrothermal treatments at 373 K (▪) and 393 K (●). Shaded areas represent elemental compositions at which selective formation of one phase (e.g., phillipsite or tobermorite) is observed.

FIG. 5 is a plot displaying total cation content and sodium content normalized by the aluminum content in the recovered solids with varying the total charge ratio after hydrothermal treatments at 373 K (▪) and 393 K (●). The total cation content is defined as the summation of individual metal cations (e.g., sodium, potassium, and calcium) normalized by the aluminum content. Shaded areas represent elemental compositions at which selective formation of one phase (e.g., phillipsite or tobermorite) is observed.

FIG. 6 is a scheme depicting a proposed mechanism for the crystallization of phillipsite and/or tobermorite (373 and 393 K, 168 h) in the presence of sodium, potassium, and calcium.

FIG. 7 displays N₂ adsorption (▪) and desorption (□) isotherms (77 K) of PHI-TOB-373-0.

FIG. 8 displays N₂ adsorption (▪) and desorption (□) isotherms (77 K) of PHI-TOB-373-0.25.

FIG. 9 displays N₂ adsorption (▪) and desorption (□) isotherms (77 K) of PHI-TOB-373-0.50.

FIG. 10 displays N₂ adsorption (▪) and desorption (□) isotherms (77 K) of PHI-TOB-373-0.75.

FIG. 11 displays N₂ adsorption (▪) and desorption (□) isotherms (77 K) of PHI-TOB-393-0.80.

FIG. 12 displays N₂ adsorption (▪) and desorption (□) isotherms (77 K) of PHI-TOB-393-1.

FIG. 13 displays TEM images of PHI-TOB-373-0.

FIG. 14 displays TEM images of PHI-TOB-393-1.

### DETAILED DESCRIPTION OF THE INVENTION

Synthesis of zeolitic materials is generally performed in basic media in the presence of metal precursors and an organic structure-directing agent (OSDA).³ Silicon and metal precursors dissociate to form amorphous particles⁴ that organize around structure-directing agents (SDA) during aging stages^{5,6} prior to crystallization of the desired zeolite topology at elevated temperatures (≥373 K).⁷ The crystallization mechanism by which SDA-free synthesis takes place, however, is a result of complex phenomena. Metal cations (e.g., Na⁺, K⁺, Ca²⁺) are typically used as a source of counterbalancing charge for the incorporation of Al heteroatoms into the framework during crystallization processes;⁸ yet they also occupy local cavities and serve as SDAs.⁹

Phillipsite and tobermorite exemplify synthesis protocols that lead to crystallization of porous, inorganic materials in the absence of an OSDA. Phillipsite precipitates in the presence of sodium,¹⁰ potassium,^{10,11} and/or calcium;¹² yet naturally-occurring phillipsite contains predominantly only sodium and potassium.¹⁰ Tobermorite, in contrast, is a porous solid that is synthesized at similar synthesis gel molar compositions (e.g., 0.38 Na₂O: 0.19 K₂O: 0.05 Al₂O₃: 1 SiO₂: 17.57 H₂O for phillipsite¹³ and 0.83 Ca: 1 Si: 18.2 H₂O for tobermorite^{14,15}) and temperatures (e.g., 373-393 K) but in growth solutions containing only calcium.

The present disclosure relates to synthesis protocols that advantageously produce zeolites have both phillipsite and tobermorite phases. Zeolite samples were prepared with varying cationic content (i.e., (2×Ca²⁺)/(K⁺+Na⁺+(2×Ca²⁺))) in the absence of an organic SDA. Our results indicate that in the absence of calcium, phillipsite is the predominant phase crystallized at 373 and 393 K, whereas tobermorite is the predominant phase crystallized in the absence of sodium and potassium. A monotonic increase in the calcium content reflects a systematic increase in the fraction of tobermorite in the recovered solids, and concomitant increase in the total cationic content occluded in the crystalline solids. The methods and compositions of the disclosure indicate that potassium has a predominant role as an Al counterbalance cation, while sodium and calcium have a predominant role as SDA. The disclosure also highlights the versatility of metal cations as charge balancing agents and inorganic SDAs during zeolite crystallization processes.

### Roles of Metal Cations on the Crystallization of Exemplary Aluminosilicates

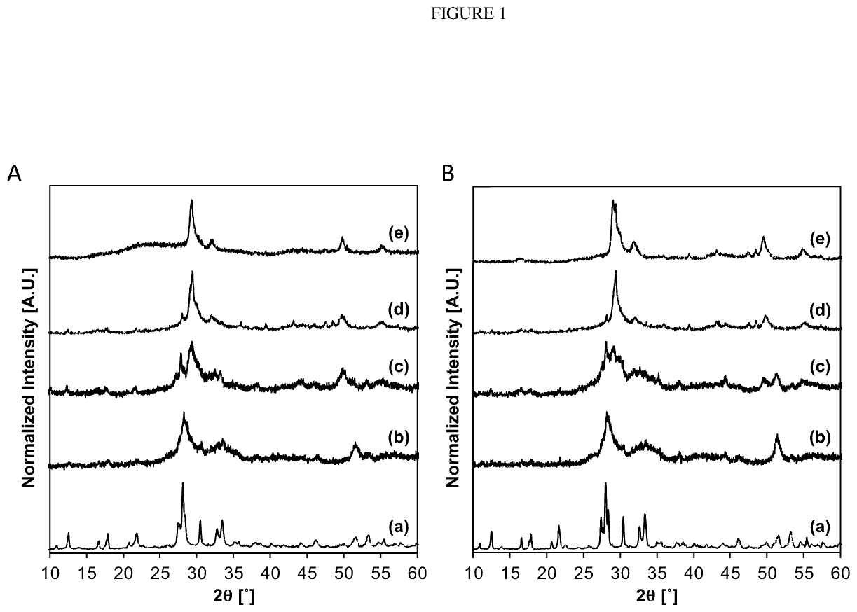

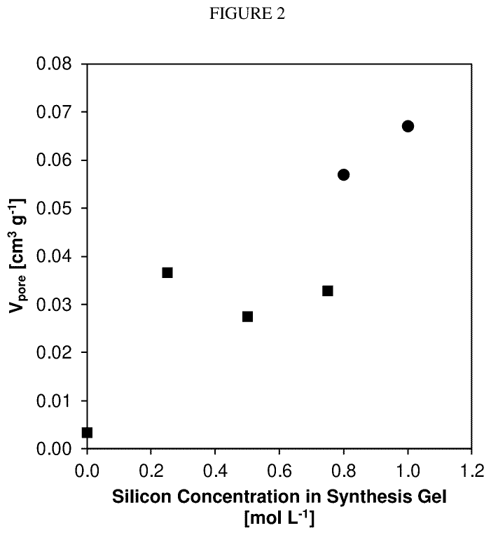

Samples are denoted as PHI-TOB-X-Y, where X represents the temperature of the hydrothermal treatment (e.g., 373 K or 393 K) and Y represents the charge ratio, defined as the fraction of calcium in the total cationic content of the synthesis gels ((2×Ca²⁺)/(K⁺+Na⁺+(2×Ca²⁺)), see experimental section). Hydrothermal treatments of synthesis gels associated with phillipsite crystallization were performed at 373 and 393 K in the sole presence of sodium and potassium (PHI-TOB-373/393-0), and the structure of the recovered solids was probed using X-ray diffraction (XRD) patterns and nitrogen adsorption isotherms (77 K). FIG. 1 contains the XRD patterns of the recovered solids of all the samples prepared in this study. XRD patterns of PHI-TOB-373/393-0.0 show primary diffraction peaks centered at 28.1 and 30.5° (FIG. 1(A)), previously observed for zeolitic samples with a phillipsite topology.²⁰ Micropore volumes (FIG. 2), measured from the semi-log derivative plot of the nitrogen adsorption isotherm, are also characteristic of phillipsite zeolites (0.003 cm³ g⁻¹),²¹⁻²³ Characteristic phillipsite prism-like and lath-like morphologies²⁴ were detected with transmission electron microscopy (TEM) images. The precipitation of inorganic solids with structural features of phillipsite indicate that, in the absence of organic structure-directing agents (OSDA), it is the predominant zeolitic phase crystallized in the presence of sodium and potassium (373 K, 168 h) as the only cationic charges in growth solutions.

Phillipsite, as a natural and synthetic zeolite, crystallizes in the presence of sodium, potassium, and/or calcium.¹⁰⁻¹² To further probe the role of the metal cations in the crystallization processes that lead to phillipsite formation, hydrothermal treatments were performed by replacing the total cationic contributions of sodium and potassium in growth solutions with calcium. Performing hydrothermal syntheses at the same total cationic charge (Na₂O+K₂O=10.45) but replacing the total metal cations with calcium (CaO=5.23) resulted in XRD patterns (FIG. 1) and micropore volumes (FIG. 2) that are different from those observed in the sole presence of sodium and potassium (FIG. 1). Specifically, XRD patterns of PHI-TOB-373/393-1.0 have distinctive diffraction peaks centered at 29.4 and 49.9°, and 10×higher micropore volumes (0.03 cm³ g⁻¹). TEM images of the recovered solids illustrate an acicular morphology. These XRD patterns, micropore volumes, and morphological parameters are characteristic of Al-tobermorite (referred as tobermorite in this manuscript) silicate hydrates.^{14,15,25-27}

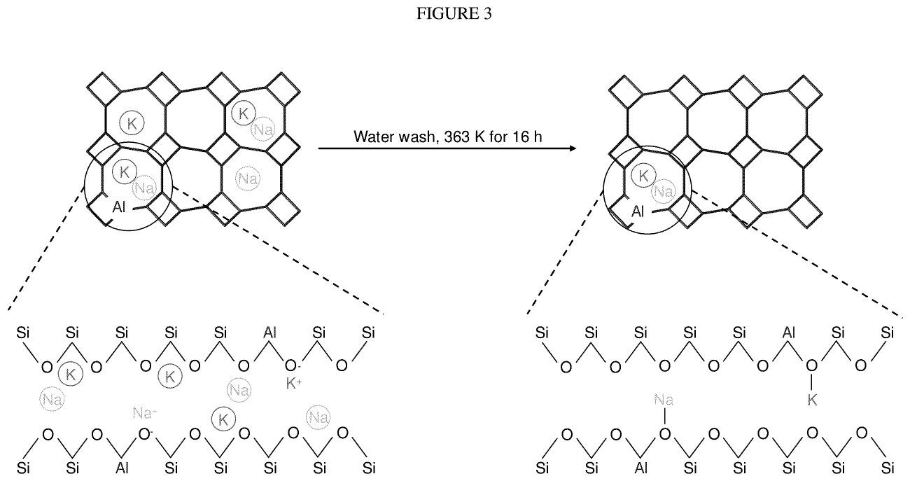

Metal cations in synthesis gels have varied roles during hydrothermal processes in the absence of OSDAs. An illustration of the roles of metal cations in the microporous cavities of phillipsite after heat treatments (373 K, 168 h) is enclosed in FIG. 3. Isomorphous substitution of aluminum heteroatoms in siliceous frameworks results in a localized anionic charge on an adjacent oxygen imparted by differences in the oxidation state of silicon (Si⁴⁺) and aluminum (Al³⁺) when tetrahedrally-coordinated. The first role of metal cations is to compensate this mismatch in framework charges imparted by aluminum incorporation. This counterbalancing role takes place using monovalent cations (e.g., Na⁺ and/or K⁺) for aluminum that have no nearby aluminum neighbor (“isolated” aluminum, Al—O(—Si—O)ₓ—Al, x≥3) and divalent cations (e.g., Ca²⁺) in frameworks that can accommodate aluminum heteroatoms separated by one or two silicon atoms (“paired” aluminum, Al—O(—Si—O)ₓ—Al, x=1, 2).²⁸ In absence of OSDAs, as is the case in the syntheses performed in this study, metal cations organize within the microporous cavities during crystallization processes to become inorganic SDAs.

In synthesis gels of PHI-TOB-373/393-0.0, sodium and potassium account for aluminum counterbalance and as SDA, and we probed their total contribution through elemental analysis. Table 1 contains the elemental composition, collected via induced coupled plasma optical emission spectroscopy (ICP-OES), of the solids recovered for all the syntheses performed in this study. The potassium content is higher than the sodium content in samples prepared at varied temperatures (373 and 393 K), accounting for >50% of the total cations retained with respect to the aluminum content. Although sodium is in excess (2:1 ratio) in synthesis gels when compared to potassium, the sodium content accounts for <40% of the total cations in the solids relative to the retained aluminum.

The total cationic content, defined as the summation of all the metal cations normalized to the aluminum content, is ≤1 for samples prepared in the absence of calcium in growth solutions (PHI-TOB-373/393-0.0, Table 1). The implication of these results, collected after water washing steps intended to remove unreacted species, is that the remaining metal cations are participating as counterbalance cations for aluminum in the framework (assuming that all the aluminum is in a tetrahedral coordination) and those participating in template roles have been selectively removed during washing steps. Consequently, the elemental compositions of PHI-TOB-373/393-0.0, together with the excess of sodium in growth solutions, suggest that the primary role of sodium (Na/Al<40%, Table 1) during hydrothermal treatments is as a SDA and gets removed during washing steps. By extension, our results indicate that potassium (K/Al>50%) has a predominant role as an aluminum counterbalance cation during crystallization of phillipsite zeolites at 373 and 393 K. Zeolites prepared in the sole presence of calcium (PHI-TOB-373-1.0) also contain metal cationic contents that account for less than the total aluminum content (Cat./Al≤1, Table 1), suggesting that the retention of metal cations during tobermorite crystallization procedures are predominantly associated with aluminum heteroatoms. Taken together, these results exemplify the structure-directing role of metal cations in crystallization processes in the absence of SDAs.

Zeolite polymorphism driven by the judicious choice of inorganic SDAs highlights the adaptable capabilities of metal cations in zeolite crystallization protocols.²⁹ Hydrothermal treatments of growth solutions replacing sodium with potassium, for instance, leads to the formation of NU-10 (TON) rather than MFI (523 K, 122 h),³⁰ synthesis gels containing potassium instead of sodium crystallize EDI rather than LTA (468 K, 96 h),³¹ and synthesis gels containing varying mixtures of sodium and potassium crystallize LTA, SOD, and/or FAU (429 K, 168 h),³² amongst others.²⁹ Here, replacing sodium and potassium with calcium in synthesis gel compositions that typically crystallize phillipsite,¹³ results in the precipitation of tobermorite, a silicate hydrate of different identity and pore structure. Although the elemental composition of tobermorite prepared at 373 K (PHI-TOB-373-1.0) was expected to occlude more calcium content (i.e., Ca/Al>1) and at higher densities than those measured (Ca/Al<1), the structure of the characterized solid indicates the distinctive features (FIG. 1) of tobermorite as a result of an exclusive calcium-containing growth solution. Altogether, the methods disclosed herein provide guidelines for the preparation of two different zeolitic and silicate hydrate aluminosilicates by varying the metal cation identity in the synthesis gel. We next investigate the roles and contributions of inorganic SDAs by systematically modifying the metal cation content.

### Methods of Preparing Exemplary Zeolites

The total cationic content is defined as the molar composition in the synthesis gel composed by all metal cations. Systematic substitution of the cationic content with calcium, however, requires accounting for differences between monovalent cations (Na⁺ and K⁺) and divalent cations (Ca²⁺). The role of calcium as a counterbalancing cation for aluminum incorporation is limited by the ability of a framework to accommodate two aluminum heteroatoms in close proximity (Al—O(—Si—O)ₓ—Al, x=1, 2) in order for aluminum incorporation to take place. The calcium content in the synthesis gel was defined by replacing the total molar contributions of sodium and potassium by half to retain the same total cationic charge in the synthesis gel. We define the charge ratio in the synthesis gel as the fraction of the total cationic content composed by calcium (e.g., (2×Ca²⁺)/(K⁺+Na⁺+(2×Ca²⁺))).

The transition from phillipsite to tobermorite phases was probed by performing hydrothermal syntheses at varied charge ratio in synthesis growth solutions. XRD patterns of samples prepared at varied charge ratio reflect diffraction peaks centered at 29.4 and 49.9° that in some embodiments, increase concomitantly with increasing calcium content (FIG. 1). Differences in framework identity and composition are also detected in the pore volume measured by nitrogen adsorption isotherms, with a monotonic increase in the micropore volume from 0.003 to 0.03 cm³ g⁻¹ with increasing charge ratio (FIG. 2). The increase in XRD diffraction peaks associated with tobermorite (e.g., 29.4 and 49.9°), together with micropore volumes that increase concomitantly, indicate that, in some embodiments, phillipsite crystallization transitions to tobermorite crystallization with increasing the calcium content in the synthesis gel, as we discuss next with respect to the elemental composition of the recovered solids.

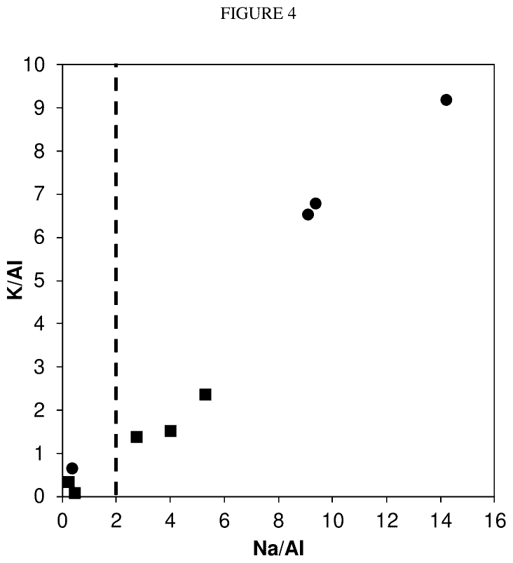

FIG. 4 compiles the potassium and sodium content in the recovered solids, normalized by the aluminum content. Normalizing the cationic molar content by the aluminum content allows for rigorous distinctions of the relevance of sodium and potassium as aluminum counterbalance cations. The sodium content increases concomitantly with the potassium content in the recovered precipitates. The sodium and potassium content also increase monotonically with increasing charge ratio for samples crystallized at 393 K (PHI-TOB-393), as diffraction peaks (e.g., peaks centered at 29.4 and 49.9°) associated with tobermorite increase concomitantly. These results indicate that the inclusion of sodium and potassium is codependent and that, although the combination of the two predominantly leads to crystallization processes associated with phillipsite, the retention of a higher fraction of these metal cations ((K+Na)/Al>1) is facilitated by tobermorite crystallization.

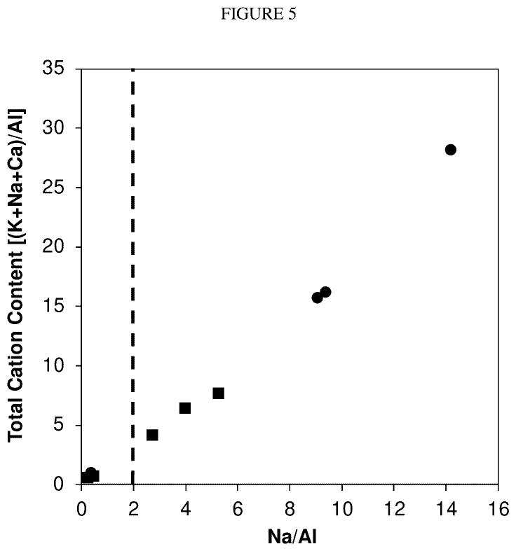

FIG. 5 compiles the total cation content with respect to the sodium content (normalized to the aluminum content). The total cationic content increases systematically with respect to the sodium content (per aluminum), and thus with increasing the fraction of tobermorite precipitation. Phillipsite phases are crystallized at total cationic charges (per Al)<2, while tobermorite phases are primarily detectable at total cationic charges>2. Retention of a higher content of metal cations at higher charge ratios, together with the formation of a higher fraction of tobermorite, suggests the bigger pores in tobermorite (˜1 nm)³³ compared to phillipsite (8 MR, ˜0.37 nm), or the mesoporous area between the two phases (observed in the hysteresis in N₂ adsorption isotherms), encapsulate more metal cations during crystallization processes. These results suggest that phillipsite zeolites primarily retain inorganic cations associated with aluminum heteroatoms, while tobermorite silicate hydrates retain metal cations corresponding to aluminum counterbalance as well as those filling the available porous cavities (SDA role). These results indicate that, either because of structural composition or the ability to retain more cations within various topologies of varied pore structure, more cations are captured within the porous architecture of tobermorite silicate hydrates compared to phillipsite zeolites.

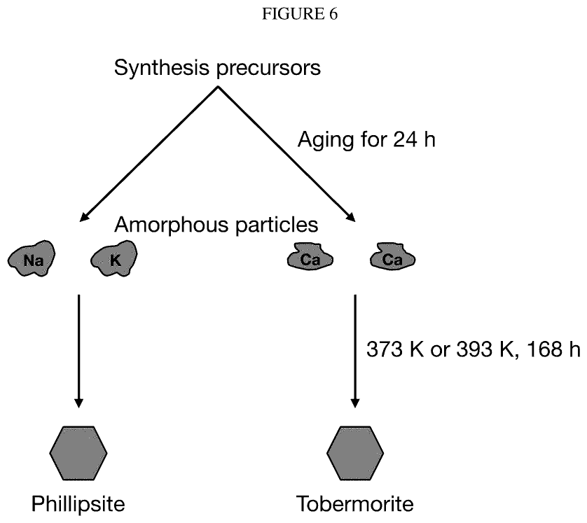

Zeolite crystallization mechanisms and polymorphism are generally described by driving forces following the Ostwald rule of stages^{34,35} or the transformation of crystalline phases guided by their molar density.^{5,29,36} Crystallization following the Ostwald rule of stages take place after dissolution of synthesis precursors to form amorphous, metastable phases that reorganize over time in stages that form more thermodynamically stable phases (e.g., from structures of less negative to more negative enthalpy of formation).^{34,35} In other instances, zeolite transformations occur by the formation of metastable phases that transform over time to form a phase with higher framework density (i.e., a framework with a lower molar volume).³⁶ In the phillipsite/tobermorite system studied here, we speculate that silicon and aluminum complexes, available in the synthesis gels after precursor dissolution during aging protocols (ambient, 24 h), nucleate metastable phases around inorganic cations. At the same time, the stabilized structure is dictated by the kinetic diameter or other physicochemical properties of the metal cations in solution (FIG. 6). These metastable phases, in turn, then dictate the aluminosilicate phase that eventually nucleates locally and crystallizes during high temperature treatments. We surmise that tobermorite, with bigger cavities than phillipsite, accommodates calcium cations and its crystallization results from high temperature treatments of aluminosilicate complexes formed around calcium during the aging step (FIG. 6). These proposed mechanistic steps, based primarily on the Ostwald rule of stages, describe general nucleation and crystallization steps that result in the crystallization of pure or mixed phillipsite and tobermorite phases in the presence of sodium, potassium, and/or calcium in varied composition in synthesis gels.

Distinguishing the ability of various metal cations to arrange within microporous and mesoporous voids allows for the preparation of porous aluminosilicates with varying pore structure. Sodium and potassium contribute to the selective crystallization of phillipsite zeolites in the absence of calcium (at 373 and 393 K). The total cationic content (normalized by Al) on PHI-TOB-373/393-0 samples suggest that the micropores of phillipsite accommodate cations exclusively to counterbalance aluminum heteroatoms. The higher total cationic content (per Al) on samples of varied charge ratio, together with detection of tobermorite phases, however, indicates that tobermorite phases retain metal cations associated with aluminum counterbalance and those that participate of structure-directing processes. The consistently higher total cationic content (per Al) in all the samples prepared at 393 K compared to those synthesized at 373 K, along with XRD features associated with tobermorite becoming prominent at low charge ratios (CR>0.3), corroborate that tobermorite porous structures accommodate metal cations that participate in aluminum counterbalance and template roles. Taken together, this study summarizes guidelines for the preparation of zeolitic phases in the absence of OSDAs and highlights the ubiquitous roles of metal cations during crystallization processes of zeolitic materials.

Synthetic protocols involving zeolite crystallization take place around OSDAs that dictate the resulting topological properties of the precipitates. In the absence of OSDAs, however, inorganic SDAs can selectively nucleate and crystallize aluminosilicates of various framework topologies depending on their identity and synthesis conditions.²⁹

The present disclosure provides methods of controlling the amounts sodium, potassium, and calcium in the crystallization of phillipsite zeolites and/or tobermorite silicate hydrates (at 373 K and 393 K) at the same total molar cationic content. In some embodiments, phillipsite zeolites are selectively crystallized (at 373 K and 393 K) from starting growth solutions that contain solely sodium and potassium, and retain metal cations at molar ratios that account only for roles associated with of aluminum counterbalance during crystallization processes ((Na+K)/Al≤1). In other embodiments, tobermorite samples are selectively crystallized after high temperature treatments (at 373 K and 393 K) of growth solutions containing solely calcium. Aluminosilicates containing tobermorite crystals retained metal cations at molar ratios ((K+Na+Ca)/Al≥1) indicating their ubiquitous roles as both aluminum counterbalance and SDA during crystallization protocols. Syntheses performed (373 K and 393 K) at mixed compositions of metal cations indicate that, in certain embodiments, the partial substitution of sodium and potassium with calcium on synthesis gels (identical total molar compositions) results in the crystallization of mixed phillipsite and tobermorite phases. Without wishing to be bound by theory, we surmise that these results are the consequence of the aluminosilicate complexes stabilized around metal cations during aging stages, leading to nucleation and crystallization of tobermorite when these complexes are encapsulating calcium cations and phillipsite when the complexes are isolating sodium and/or potassium. Taken together, the methods and compositions disclosed herein reveal the roles of metal cations during crystallization processes and highlight the ability of their identity to dictate the topological properties, tailored for specific applications, of the resulting precipitate

TABLE 1
Exemplary elemental compositions of recovered solids after hydrothermal treatments at
varied metal cation composition. All results collected via ICP-OES.

| Sample | C.R.^{a} | Si/Al | Na/Al | K/Al | Ca/Al | Cat./Al^{b} |
|---|---|---|---|---|---|---|
| PHI-TOB-373-0^{c} | 0.00 | 3.13 | 0.24 | 0.60 | — | 0.84 |
| PHI-TOB-373-0^{d} | 0.00 | 2.33 | 0.24 | 0.34 | — | 0.58 |
| PHI-TOB-373-0.25 | 0.25 | — | 5.27 | 2.35 | 0.06 | 7.68 |
| PHI-TOB-373-0.50 | 0.50 | — | 2.73 | 1.38 | 0.03 | 4.13 |
| PHI-TOB-373-0.75 | 0.75 | — | 3.99 | 1.51 | 0.89 | 6.40 |
| PHI-TOB-373-1.00 | 1.00 | — | 0.45 | 0.08 | 0.16 | 0.69 |
| PHI-TOB-393-0.00 | 0.00 | 2.78 | 0.36 | 0.64 | — | 1.01 |
| PHI-TOB-393-0.30 | 0.30 | — | 9.07 | 6.52 | 0.16 | 15.75 |
| PHI-TOB-393-0.50 | 0.50 | — | 9.38 | 6.79 | 0.04 | 16.21 |
| PHI-TOB-393-0.80 | 0.80 | — | 14.19 | 9.17 | 4.83 | 28.19 |
| PHI-TOB-393-1.00 | 1.00 | — | — | — | — | — |

^{a}Fraction of calcium compared to the total metal cations in the synthesis gel (i.e., (2 × Ca²⁺)/(K⁺ + Na⁺ + (2 × Ca²⁺))).
^{b}Metal cation content normalized by the aluminum content ((K + Na + Ca)/(Al)).
^{c}Synthesis performed at a lower water content to lower the silicon concentration to 0.2M
^{d}Synthesis performed at reported molar ratios¹³ with a silicon concentration of 3M

TABLE 2
Exemplary molar compositions of synthesis gel compositions prior to
hydrothermal treatments at 373 and 393 K.

| Sample | C.R.^{a} | Na | K | Ca | Al | Si | H₂O |
|---|---|---|---|---|---|---|---|
| PHI-TOB-373-0^{b} | 0.00 | 1.41 | 0.39 | — | 0.11 | 1 | 270.27 |
| PHI-TOB-373-0^{c} | 0.00 | 1.41 | 0.39 | — | 0.11 | 1 | 17.59 |
| PHI-TOB-373-0.25 | 0.25 | 1.06 | 0.29 | 0.22 | 0.11 | 1 | 17.59 |
| PHI-TOB-373-0.50 | 0.50 | 0.70 | 0.19 | 0.45 | 0.11 | 1 | 17.59 |
| PHI-TOB-373-0.75 | 0.75 | 0.35 | 0.10 | 0.67 | 0.11 | 1 | 17.59 |
| PHI-TOB-373-1.00 | 1.00 | — | — | 0.90 | 0.11 | 1 | 17.59 |
| PHI-TOB-393-0.00 | 0.00 | 0.99 | 0.51 | — | 0.05 | 1 | 18 |
| PHI-TOB-393-0.30 | 0.30 | 0.70 | 0.36 | 0.23 | 0.05 | 1 | 18 |
| PHI-TOB-393-0.50 | 0.50 | 0.50 | 0.26 | 0.38 | 0.05 | 1 | 18 |
| PHI-TOB-393-0.80 | 0.80 | 0.20 | 0.10 | 0.60 | 0.05 | 1 | 18 |
| PHI-TOB-393-1.00 | 1.00 | — | — | 0.83 | — | 1 | 18 |

^{a}Fraction of calcium with respect to the total metal cations in the synthesis gel (i.e., (2 × Ca²⁺)/(K⁺ + Na⁺ + (2 × Ca²⁺))).
^{b}Synthesis performed at varied water content to lower the total silicon concentration to 0.2M.
^{b}Synthesis performed at a silicon concentration of 3M.

In certain embodiments, the present disclosure provides a zeolite having a micropore volume from about 0.001 to about 0.1 cm³/g, comprising Al, Si, O, H, Na, K and Ca;

wherein the zeolite comprises:
a total cation content:aluminum ratio (Cat:Al) from about 0.4 to about 40, defined by formula I:

((K+Na+Ca)/(Al)) (I);
a sodium:aluminum ratio (Na:Al) of from about 0.1 to about 16;
a potassium:aluminum ratio (K/Al) of from about 0.01 to about 15; and
a calcium:aluminum ratio (Ca/Al) of from about 0.001 to about 10.

The micropore volume, in some embodiments, is from about 0.002 to about 0.08 cm³/g, or about 0.001 to about 0.003 cm³/g. In more particular embodiments, the micropore volume is about 0.02 to about 0.03 cm³/g, about 0.03 to 0.04 cm³/g, about 0.05 to about 0.06 cm³/g, about to about 0.07 cm³/g, or about 0.07 to about 0.08 cm³/g.

In certain embodiments, the total cation content:aluminum ratio Cat:Al is from about 0.5 to about 30. In more particular embodiments, Cat:Al is about 0.5 to about 0.71, about 1 to about 2, about 2 to about 5, about 5 to about 8, about 8 to about 12, about 12 to about 15, about 15 to about 20, or about 20 to about 30.

In some embodiments, Na:Al is from about 0.1 to about 15, such as about 0.1 to about 1, about 1 to about 5, about 5 to about 10, about 5 to about 15, or about 10 to about 15.

In some embodiments, K:Al is from about 0.05 to about 10, for example about 0.05 to about 1, about 1 to about 2, about 2 to about 5, about 5 to about 7, about 7 to about 10, about to about 5.

In some embodiments, Ca:Al is about 0.02 to about 0.5, for example about 0.5 to about 1, about 1 to about 2, about 2 to about 3, about 3 to about 4, about 4 to about 5.

In some embodiments, the zeolite is characterized by X-Ray powder diffraction peaks at 29.4°±0.2 and 49.9°±0.2. In particular embodiments, the X-Ray powder diffraction peaks 29.4°±0.2 and 49.9°±0.2 increase in strength as Ca:Al increases. In more particular embodiments, the zeolite has an X-Ray powder diffraction pattern as shown in FIG. 1A(b), (c), or (d), or 1B(b), (c), or (d).

Other embodiments relate to a method of preparing a zeolite, the method comprising:
preparing a synthesis gel, the synthesis gel comprising
aNa₂O:bK₂O:cCaO:dAl₂O₃:eSiO₂:fH₂O, wherein
   a is from about 0.01 to about 5,
   b is from about 0.01 to about 1,
   c is from about 0.01 to about 2,
   d is from about 0.01 to about 0.5,
   e is from about 0.1 to about 2,
   f is from 10 to about 50; and
further wherein the fraction of calcium in the total cationic content of the synthesis gel is represented by a charge ratio (R_{C}), wherein R_{C} is described by formula II:

(2x)/(y+z+(2x))=R_{C} (II);
wherein x represents the number of calcium cations present in the synthesis gel;
y represents the number of potassium cations present in the synthesis gel;
z represents the number of sodium cations present in the synthesis gel; and
R_{C} is between 0 and 1;
   aging the synthesis gel;
   heating the synthesis gel to produce a product mixture; and
   collecting the zeolite from the product mixture.

In some embodiments, aging the synthesis gel comprises a treatment selected from mechanical agitation, stirring, shaking, swirling, sonication, and any combination thereof. In certain embodiments, aging the synthesis gel does not comprise heating the synthesis gel. In wherein aging the synthesis gel occurs at about 20-30° C.

In some embodiments, heating the synthesis gel comprises heating the synthesis gel to a reaction temperature of from about 350 K to about 410 K, more particularly, from about 350 K to about 400 K and even more particularly from about 370 K to about 395 K, such as about 373 K or about 393 K.

In some embodiments, collecting the zeolite from the product mixture comprises washing the zeolite with water, isolating the zeolite by centrifugation, and drying the zeolite.

In some embodiments, Rc is from about 0.01 to about 0.99, such as about 0.1 to about about 0.2 to about 0.3, about 0.3 to about 0.4, about 0.4 to about 0.5, about 0.5 to about 0.6, about 0.6 to about 0.7, about 0.7 to about 0.8, or about 0.8 to about 0.9.

In some embodiments, a is from about 0.1 to about 3, such as about 0.1 to about 0.2, about 0.2 to about 0.4, about 0.4 to about 0.6, about 0.6 to about 0.8, about 0.8 to about 1, or about 1 to about 1.5.

In some embodiments, b is from about 0.1 to about 1, for example about 0.1 to about 0.2, about 0.2 to about 0.3, about 0.3 to about 0.5, about 0.5 to about 0.6, or about 0.1 to about 2.

In some embodiments, c is from about 0.1 to about 0.2, about 0.2 to about 0.3, about 0.3 to about 0.4, about 0.4 to about 0.5, about 0.5 to about 0.6, about 0.6 to about 0.7, about 0.7 to about 0.8, about 0.8 to about 0.9, or about 0.9 to about 0.1.

In some embodiments, d is from about 0.01 to about 0.4, such as about 0.01 to about about 0.05 to about 0.1, or d is from about 0.1 to about 0.3.

In some embodiments, e is from about 0.5 to about 1.5, such as about 1.

In some embodiments, f is from about 10 to about 40, such as about 10 to about 30, about to about 15, or about 15 to about 20.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

The term “aging” refers to a process of allowing or driving a mixture to reach or approach a desired product or stage. A number of approaches may be used to age a mixture. It may be heated or cooled, treated with mechanical agitation (such as stirring, swirling, shaking, or vibrations), sonicated, or simply allowed to rest for a period of time — or some combination of these treatments, whether applied together or in series, or in any other combination.

All of the above, and any other publications, patents and published patent applications referred to in this application are specifically incorporated by reference herein. In case of conflict, the present specification, including its specific definitions, will control.

### EXAMPLES

The invention now being generally described, it will be more readily understood by reference to the following examples which are included merely for purposes of illustration of certain aspects and embodiments of the present invention, and are not intended to limit the invention.

### Example 1: Synthesis of Exemplary Zeolites

Phillipsite zeolites (PHI-TOB-373/393-0) were synthesized according to the following procedure.¹³ In a typical synthesis, potassium hydroxide (KOH, Avantor, 98%) was added to deionized water (18.2 MΩ) and stirred until completely dissolved in a Nalgene wide-mouth HDPE bottle (250 cm³, ThermoFisher Scientific). Then, sodium aluminate was added and the resulting mixture was stirred until completely dissolved. Lastly, sodium silicate was added to the Nalgene container. The resulting gel solution was covered and stirred for 24 h at ambient conditions. The final gel composition was 6.95 Na₂O: 3.5 K₂O: 1 Al₂O₃: 18.5 SiO₂: 325 H₂O. The gel was placed into a Teflon-lined stainless steel autoclave and heated to 373 or 393 K for 7 days under static conditions. The recovered solids were washed thoroughly with water, isolated by centrifugation, and dried overnight at 363 K.

The charge ratio, or the amount of calcium in the synthesis gel, was modified by the following procedure. In a typical synthesis, potassium hydroxide (KOH, 86.6%) was added to deionized water (18.2 MΩ) and stirred until completely dissolved in a Nalgene bottle (250 cm³). Then, sodium hydroxide (NaOH, 98.7%) was added and the resulting mixture was stirred until completely dissolved. Calcium hydroxide (Ca(OH)₂, 100%) and aluminum hydroxide (Al(OH)₃, 99%) were added individually and the mixture was stirred until complete dissolution. Lastly, Ludox SM30 (30 wt. % in water) was added to the Nalgene container. The resulting gel solution was covered and stirred for 24 h at ambient conditions. The final gel composition was x Na₂O: y K₂O: z CaO: 1 Al₂O₃: 18.5 SiO₂: 325 H₂O, where x, y, and z were modified to attain a given charge ratio (e.g., 0.25-0.80). More details and the specific gel compositions for all the samples in this study are compiled in Table 2. The gel was placed into a Teflon-lined stainless steel autoclave and heated to 373 or 393 K for 7 days under static conditions. The recovered solids were washed thoroughly with water, isolated by centrifugation, and dried overnight at 363 K.

Tobermorite silicate hydrates (PHI-TOB-373/393-1) were synthesized according to the following procedure.¹⁴⁻¹⁹ In a typical synthesis, calcium hydroxide (Ca(OH)₂, 100%, 10 μm particle size) was added to deionized water (18.2 MΩ) and stirred until completely dissolved in a Nalgene bottle. Then, Ludox SM30 was added and the resulting mixture was stirred until completely dissolved. At 373 K (PHI-TOB-373-1), aluminum hydroxide (Strem Chemicals) was added and the resulting solution was stirred until complete dissolution (0.11 Al₂O₃: 0.90 CaO: 1 SiO₂: 17.59 H₂O). The resulting gel solution was covered and stirred for 24 h at ambient conditions. The final gel composition was 0.83 CaO: 1 SiO₂: 18.2 H₂O. The gel was placed into a Teflon-lined stainless steel autoclave and heated to 373 or 393 K for 7 days under static conditions. The recovered solids were washed thoroughly with water, isolated by centrifugation, and dried overnight at 363 K.

For simplicity, samples are referred to as PHI-TOB-X-Y, where X represents the temperature at which the hydrothermal treatment was performed (e.g., 373 K or 393 K) and Y represents the charge ratio (fraction of calcium in the total cationic content).

### Example 2: Exemplary Methods of Zeolite Characterization

Powder X-ray diffraction (XRD) patterns were collected in the range 5-70° of 2θ (scan rate of 0.0765° s⁻¹ and a step size of 0.02°) using a PANalytical X'PertPro X-ray diffractometer with a Cu Kα x-ray source (α=1.54 Å) and an X'Celerator 2 detector.

Vapor-phase N₂ (77 K) adsorption isotherms were collected with a Micromeritics TriStar II 3020 instrument. Typically, ˜.0.20 g of zeolite sample, pelleted and sieved to retain particles with size between 180-250 μm, were degassed by heating under vacuum (<0.1 Torr) to 383 K for 24 h prior to adsorption measurements. The micropore volume was determined from semi-log derivative analysis of the isotherm (∂(V_{ads}/g)/∂(log(P/P₀) vs. log(P/P₀)), where the first maximum represents the micropore filling transition and the subsequent minimum represents the end of micropore filling.

The elemental composition of the recovered solids was measured using an inductively-coupled-plasma optical emission spectrometer (ICP-OES, Varian Vista-MPX). Samples (˜0.03 g) were dissolved overnight in 2 g of HF (48 wt. %, Alfa Aesar) and diluted with ˜50 g of deionized water. In a separate 15 cm³ centrifuge tube, ˜10 g of the resulting solution and 0.1 g of nitric acid were mixed prior to measurements. The Si/Al ratios of PHI-TOB-373/393-0 were calculated using the unit cell formula for the PHI framework topology.

Transmission electron microscope (TEM) images were collected after samples (<20 mg) were dispersed in ethanol for 240 s in an ultrasonic bath. Approximately 4 drops of the dispersion were deposited in a 200 mesh Cu grid with a C film. TEM bright field images were taken with a JEOL JEM-2100F TEM/STEM operated at 200 keV, with spot size 1 and magnifications between 12 and 20 kx.

### Example 3: Characterization of Physicochemical Properties of Exemplary Zeolites

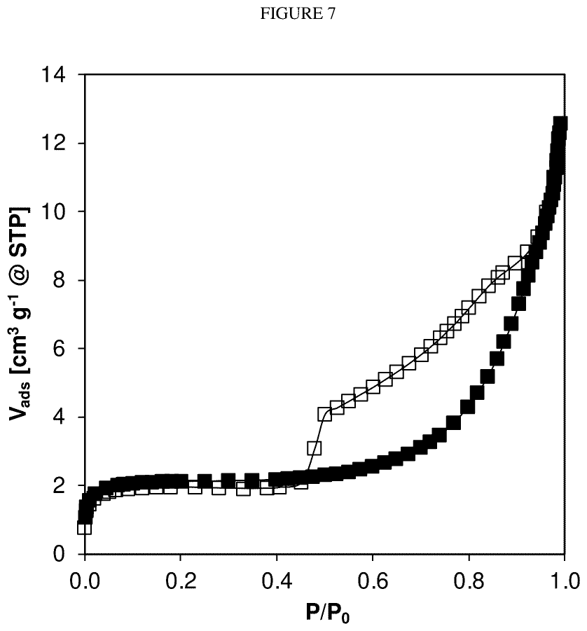

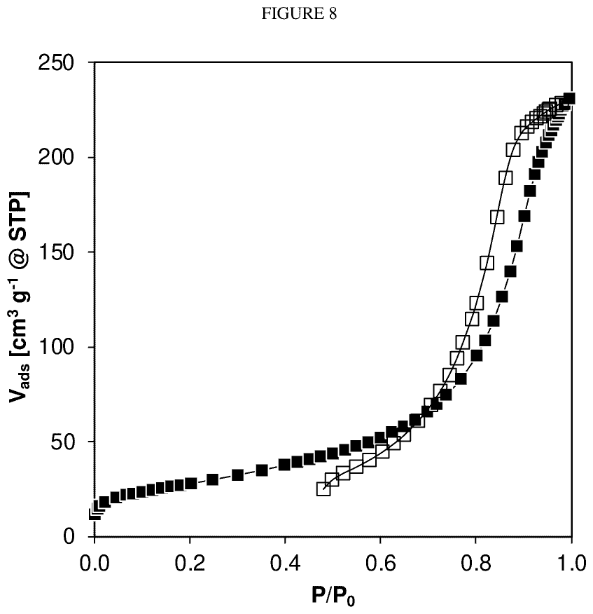

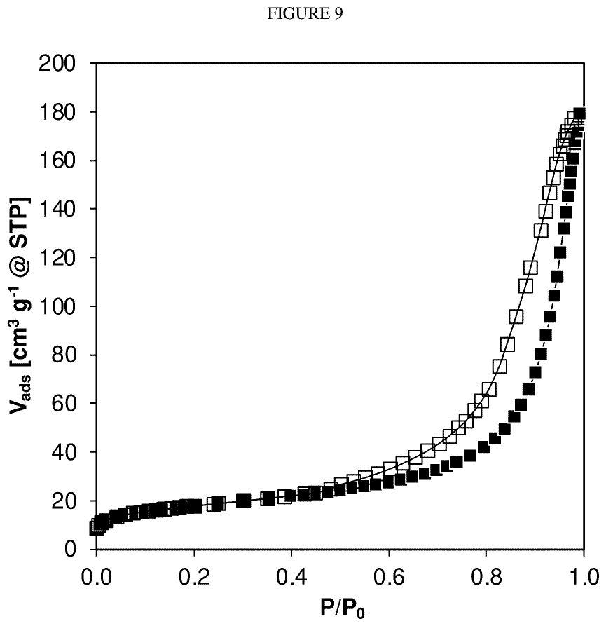

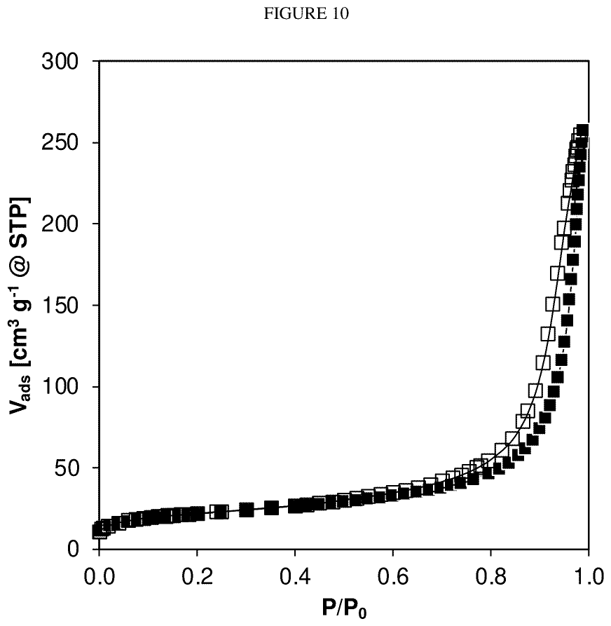

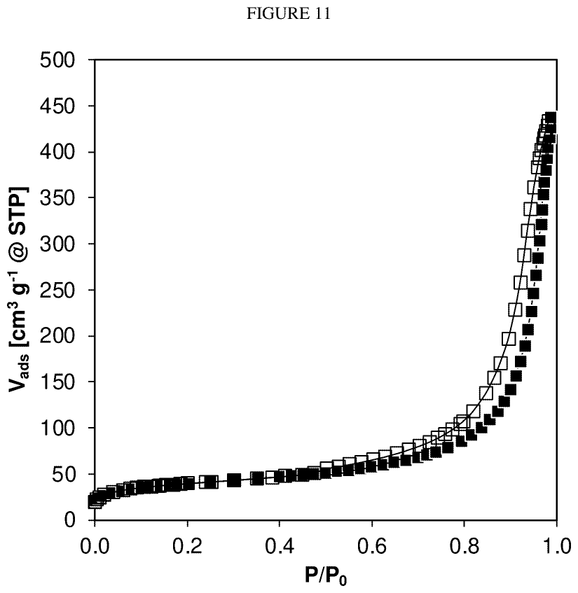

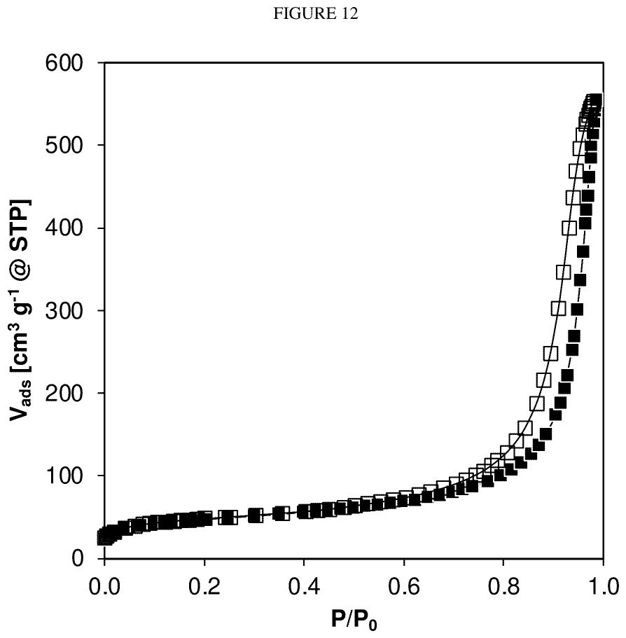

N₂ adsorption isotherms (77 K) are compiled in FIGS. 7-12 on all phillipsite and tobermorite samples. Samples are referred to as PHI-TOB-X-Y, where X is the temperature of the hydrothermal treatment and Y is the charge ratio (fraction of the cationic content provided by calcium, Ca/(K+Na+Ca)). Micropore volumes (cm³ g⁻¹) were determined from semi-log derivative analysis of the isotherm (∂(V_{ads}/g)/∂(log(P/P₀) vs. log(P/P₀)), where the first maximum represents the micropore filling transition and the subsequent minimum represents the end of micropore filling. The hysteresis observed in the desorption portion of the isotherms indicate the presence of mesoporous cavities within PHI-TOB samples.

### Example 4: Morphological Signatures of Exemplary Zeolites

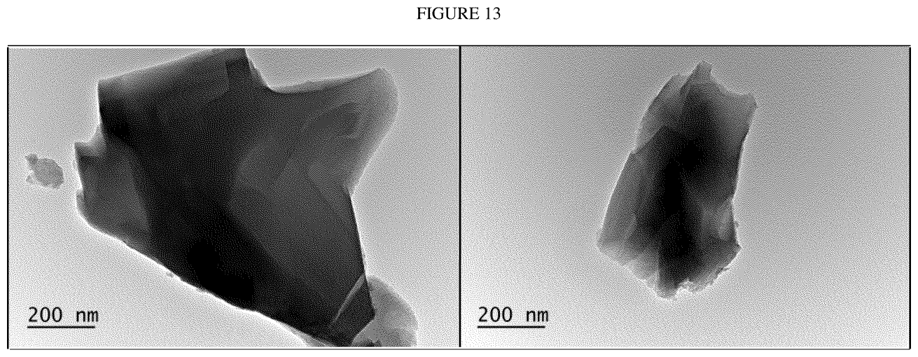

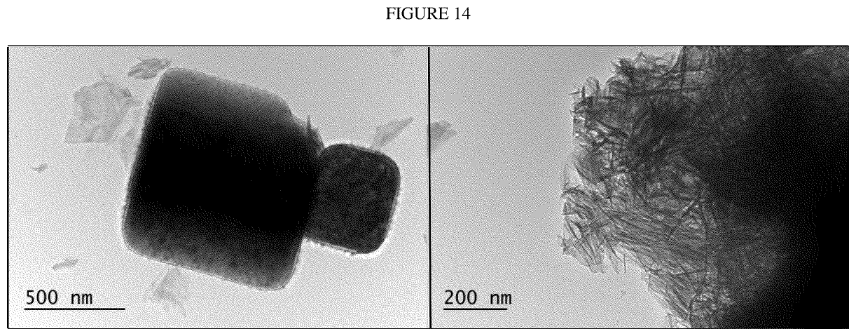

Transmission electron microscope (TEM) images were taken on PHI-TOB-373-0 (FIG. 13) and PHI-TOB-393-1 (FIG. 14). Phillipsite samples (FIG. 13, PHI-TOB-373-0) show planar surfaces that agglomerate to form thick plates, in accordance with their typical prism-like to lath-like morphology with “cracking” along cleavage surfaces.³⁷ Defined planar surfaces, as well as agglomeration of needle-like crystals, however, are observed for tobermorite samples (FIG. 14). These observation corroborate the presence of tobermorite silicate hydrates as they traditionally exhibit an acicular (e.g., needle-like) morphology that extend among one axis as crystallization processes take place.³⁸⁻⁴⁰
(1) García, E. J.; Pérez-Pellitero, J.; Pirngruber, G. D.; Jallut, C.; Palomino, M.; Rey, F.;

Valencia, S. Tuning the Adsorption Properties of Zeolites as Adsorbents for CO2 Separation: Best Compromise between the Working Capacity and Selectivity. Ind. Eng. Chem. Res. 2014, 53 (23), 9860-9874. https://doi.org/10.1021/ie500207s.
(2) C̆ejka, Jir̆i; Corma, Avelino; Zones, Stacey. Zeolites and Catalysis: Synthesis, Reactions and Applications; John Wiley & Sons, Ltd, 2010.
(3) Cubillas, P.; Anderson, M. W. Synthesis Mechanism: Crystal Growth and Nucleation. In

Zeolites and Catalysis; John Wiley & Sons, Ltd, 2010; pp 1-55. https://doi.org/10.1002/9783527630295.ch1.
(4) Smaihi, M.; Barida, 0.; Valtchev, V. Investigation of the Crystallization Stages of LTA-Type Zeolite by Complementary Characterization Techniques. European Journal of Inorganic Chemistry 2003, 2003 (24), 4370-4377. https://doi.org/10.1002/ejic.200300154.
(5) Cundy, C. S.; Cox, P. A. The Hydrothermal Synthesis of Zeolites: Precursors, Intermediates and Reaction Mechanism. Microporous and Mesoporous Materials 2005, 82 (1), 1-78. https://doi.org/10.1016/j.micromeso.2005.02.016.
(6) Grand, J.; Awala, H.; Mintova, S. Mechanism of Zeolites Crystal Growth: New Findings and Open Questions. CrystEngComm 2016, 18 (5), 650-664. https://doi.org/10.1039/C5CE02286J.
(7) Bozhilov, K. N.; Le, T. T.; Qin, Z.; Terlier, T.; Palc̆ić, A.; Rimer, J. D.; Valtchev, V. Time-Resolved Dissolution Elucidates the Mechanism of Zeolite MFI Crystallization. Sci. Adv. 2021, 7 (25), 1-10.
(8) Yokoi, T.; Mochizuki, H.; Namba, S.; Kondo, J. N.; Tatsumi, T. Control of the Al Distribution in the Framework of ZSM-5 Zeolite and Its Evaluation by Solid-State NMR Technique and Catalytic Properties. J. Phys. Chem. C 2015, 119 (27), 15303-15315. https://doi.org/10.102 Vacs jpcc.5b03289.
(9) Borel, M.; Dodin, M.; Daou, T. J.; Bats, N.; Patarin, J. Formation Domain of SDA-Free Y

Faujasite Small Crystals. New J. Chem. 2017, 41 (22), 13260-13267. https://doi.org/10.1039/C7NJ02200J.
(10) Steinfink, H. The Crystal Structure of the Zeolite, Phillipsite. Acta Crystallographica 1962, 15 (7), 644-651. https://doi.org/10.1107/50365110X62001802.
(11) Hou, J.; Yuan, J.; Xu, J.; Sun, L. Synthesis and Characterization of K-Phillipsite (K-PHI)

Membrane for Potassium Extraction from Seawater. Microporous and Mesoporous Materials 2013, 172, 217-221. https://doi.org/10.1016/j.micromeso.2013.01.034.
(12) Passaglia, E.; Vezzalini, G.; Carnevali, R. Diagenetic Chabazites and Phillipsites in Italy: Crystal Chemistry and Genesis. European Journal of Mineralogy 1990, 2 (6), 827-840. https://doi.org/10.1127/ej m/2/6/0827.
(13) Cichocki, A.; Grochowski, J.; Lebioda, L. Phillipsite-Type Synthetic Zeolite with High

Silica Contents and Accompanying Phases. Kristall Und Technik-Crystal Research and Technology, 1979, 14, 9-18. https://doi.org/10.1002/crat.19790140103.
(14) Mitsuda, T.; Taylor, H. F. W. Influence of Aluminium on the Conversion of Calcium Silicate Hydrate Gels into 11 Å Tobermorite at 90° C. and 120° C. Cement and Concrete Research, 1975, 5, 203-209. https://doi.org/10.1016/0008-8846(75)90001-0.
(15) Elhemaly, S. A. S.; Mitsuda, T.; Taylor, H. F. W. Synthesis of Normal and Anomalous Tobermorites. Cement and Concrete Research, 1977, 7, 429-438.
(16) Hong, S.-Y.; Glasser, F. P. Phase Relations in the CaO—SiO2—H2O System to 200° C. at Saturated Steam Pressure. Cement and Concrete Research 2004, 34 (9), 1529-1534. https://doi.org/10.1016/j.cemconres.2003.08.009.
(17) Shaw, S.; Clark, S. M.; Henderson, C. M. B. Hydrothermal Formation of the Calcium Silicate Hydrates, Tobermorite (Ca5SiO6O16(OH)2·4H2O) and Xonotlite (Ca6Si6O17(OH)2): An in Situ Synchrotron Study. Chemical Geology 2000, 167 (1), 129-140. https://doi.org/10.1016/S0009-2541(99)00205-3.
(18) Gabrovs̆ek, R.; Kurbus, B.; Mueller, D.; Wieker, W. Tobermorite Formation in the System CaO, C3S—SiO2—Al2O3-NaOH—H2O under Hydrothermal Conditions. Cement and Concrete Research 1993, 23 (2), 321-328. https://doi.org/10.1016/0008-8846(93)90097-S.
(19) Huang, X. A.; Jiang, D. L.; Tan, S. H. Novel Hydrothermal Synthesis of Tobermorite

Fibers Using Ca(II)-EDTA Complex Precursor. Journal of the European Ceramic Society, 2003, 23, 123-126. https://doi.org/10.1016/s0955-2219(02)00066-3.
(20) Oleksiak, M. D.; Ghorbanpour, A.; Conato, M. T.; McGrail, B. P.; Grabow, L. C.; Motkuri, R. K.; Rimer, J. D. Synthesis Strategies for Ultrastable Zeolite GIS Polymorphs as Sorbents for Selective Separations. Chemistry-a European Journal, 2016, 22, 16078-16088. https://doi.org/10.1002/chem.201602653.
(21) García, J. E.; González, M. M.; Notario, J. S. Phenol Adsorption on Natural Phillipsite. Reactive Polymers 1993, 21 (3), 171-176. https://doi.org/10.1016/0923-1137(93)90119-Z.
(22) Notario, J. S.; Garcia, J. E.; Caceres, J. M.; Arteaga, I. J.; Gonzalez, M. M. Characterization of Natural Phillipsite Modified with Orthophosphoric Acid. Applied Clay Science 1995, 10 (3), 209-217. https://doi.org/10.1016/0169-1317(95)00025-Y.
(23) OsackýM.; Pálková, H.; Hudec, P.; Czímerová, A.; Galusková, D.; Vitková, M. Effect of Alkaline Synthesis Conditions on Mineralogy, Chemistry and Surface Properties of Phillipsite, P and X Zeolitic Materials Prepared from Fine Powdered Perlite by-Product. Microporous and Mesoporous Materials 2020, 294, 109852. https://doi.org/10.1016/j.micromeso.2019.109852 .
(24) Mumpton, F. A.; Ormsby, W. C. Morphology of Zeolites in Sedimentary Rocks by Scanning Electron Microscopy. Clays and Clay Minerals 1976, 24 (1), 1-23. https://doi.org/10.1346/CCMN.1976.0240101.
(25) Diez-Garcia, M.; Gaitero, J. J.; Dolado, J. S.; Aymonier, C. Ultra-Fast Supercritical Hydrothermal Synthesis of Tobermorite under Thermodynamically Metastable Conditions. Angewandte Chemie-International Edition, 2017, 56, 3162-3167. https://doi.org/10.1002/anie.201611858.
(26) Huang, X.; Jiang, D.; Tan, S. Novel Hydrothermal Synthesis Method for Tobermorite Fibers and Investigation on Their Thermal Stability. Materials Research Bulletin 2002, 37 (11), 1885-1892. https://doi.org/10.1016/50025-5408(02)00854-1.
(27) Galvánková, L.; Masilko, J.; Solný, T.; S̆tĕpánková, E. Tobermorite Synthesis Under Hydrothermal Conditions. Procedia Engineering 2016, 151, 100-107. https://doi.org/10.1016/j.proeng .2016.07.394.
(28) Di Iorio, J. R.; Gounder, R. Controlling the Isolation and Pairing of Aluminum in Chabazite

Zeolites Using Mixtures of Organic and Inorganic Structure-Directing Agents. Chemistry of Materials, 2016, 28, 2236-2247. https://doi.org/10.1021/acs.chemmater.6b00181.
(29) Oleksiak, M. D.; Rimer, J. D. Synthesis of Zeolites in the Absence of Organic Structure-Directing Agents: Factors Governing Crystal Selection and Polymorphism. Reviews in Chemical Engineering 2014, 30 (1), 1-49. https://doi.org/doi:10.1515/revce-2013-0020.
(30) Lowe, B. M.; Nee, J. R. D.; Casci, J. L. Crystallization of “Inorganic” ZSM-5 in the System K2O—Al2O3-SiO2-H2O. Zeolites 1994, 14 (8), 610-619. https://doi.org/10.1016/0144-2449(94)90116-3.
(31) Jakkula, V. S.; Williams, C. D.; Hocking, T. J.; Fullen, M. A. High Selectivity and Affinity of Linde Type F towards NH4+ on Application as a Soil Amendment for Maize Growth. Microporous and Mesoporous Materials 2006, 88 (1), 101-104. https://doi.org/10.1016/j.micromeso.2005.09.001.
(32) Basaldella, E. I.; Tara, J. C. Synthesis of LSX Zeolite in the NaK System: Influence of the

NaK Ratio. Zeolites 1995, 15 (3), 243-246. https://doi.org/10.1016/0144-2449(94)00006-E.
(33) Merlino, S.; Bonaccorsi, E.; Armbruster, T. The Real Structure of Tobermorite 11 Å: Normal and Anomalous Forms, OD Character and Polytypic Modifications. European Journal of Mineralogy 2001, 13 (3), 577-590. https://doi.org/10.1127/0935-1221/2001/0013-0577.
(34) Navrotsky, A. Energetic Clues to Pathways to Biomineralization: Precursors, Clusters, and

Nanoparticles. Proceedings of the National Academy of Sciences 2004, 101 (33), 12096-12101. https://doi.org/10.1073/pnas.0404778101.
(35) Navrotsky, A.; Trofymluk, 0.; Levchenko, A. A. Thermochemistry of Microporous and Mesoporous Materials. Chem. Rev. 2009, 109 (9), 3885-3902. https://doi.org/10.1021/cr800495t.
(36) Maldonado, M.; Oleksiak, M. D.; Chinta, S.; Rimer, J. D. Controlling Crystal Polymorphism in Organic-Free Synthesis of Na-Zeolites. J. Am. Chem. Soc. 2013, 135 (7), 2641-2652. https://doi.org/10.1021/ja3105939.
(37) Mumpton, F. A.; Ormsby, W. C. Morphology of Zeolites in Sedimentary Rocks by Scanning Electron Microscopy. Clays and Clay Minerals 1976, 24 (1), 1-23. https://doi.org/10.1346/CCMN.1976.0240101.
(38) Diez-Garcia, M.; Gaitero, J. J.; Dolado, J. S.; Aymonier, C. Ultra-Fast Supercritical Hydrothermal Synthesis of Tobermorite under Thermodynamically Metastable Conditions. Angewandte Chemie-International Edition 2017, 56 (12), 3162-3167. https://doi.org/10.1002/anie.201611858.
(39) Huang, X.; Jiang, D.; Tan, S. Novel Hydrothermal Synthesis Method for Tobermorite Fibers and Investigation on Their Thermal Stability. Materials Research Bulletin 2002, 37 (11), 1885-1892. https://doi.org/10.1016/50025-5408(02)00854-1.
(40) Galvánková, L.; Másilko, J.; Solný, T.; S̆tĕpánková, E. Tobermorite Synthesis Under Hydrothermal Conditions. Procedia Engineering 2016, 151, 100-107. https://doi.org/10.1016/j.proeng.2016.07.394.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A zeolite having a micropore volume from about 0.001 to about 0.1 cm3/g, comprising Al, Si, O, H, Na, K and Ca;
wherein the zeolite comprises:
a total cation content:aluminum ratio (Cat:Al) from about 0.4 to about 40, defined by formula I:
((K+Na+Ca)/(Al)) (I);
a sodium:aluminum ratio (Na:Al) of from about 0.1 to about 16;
a potassium:aluminum ratio (K/Al) of from about 0.01 to about 15; and
a calcium:aluminum ratio (Ca/Al) of from about 0.001 to about 10.

2. The zeolite of claim 1, wherein the micropore volume is from about 0.002 to about 0.08 cm3/g.

3-8. (canceled)

9. The zeolite of claim 1, wherein Cat:Al is from about 0.5 to about 30.

10-17. (canceled)

18. The zeolite of claim 1, wherein Na:Al is from about 0.1 to about 15.

19-23. (canceled)

24. The zeolite of claim 1, wherein K:Al is from about 0.05 to about 10.

25-29. (canceled)

30. The zeolite of claim 1, wherein Ca:Al is from about 0.02 to about 5.

31-36. (canceled)

37. The zeolite of claim 1, wherein the zeolite is characterized by X-Ray powder diffraction peaks at 29.4°±0.2 and 49.9°±0.2.

38. The zeolite of claim 37, wherein the X-Ray powder diffraction peaks increase in strength as Ca:Al increases.

39. The zeolite of claim 38, exhibiting an X-Ray powder diffraction pattern as shown in FIG. 1A(b), (c), or (d), or 1B(b), (c), or (d).

40. A method of preparing the zeolite of claim 1, the method comprising:
preparing a synthesis gel, the synthesis gel comprising aNa2O:bK2O:cCaO:dAl2O3:eSiO2:fH2O, wherein
a is from about 0.01 to about 5,
b is from about 0.01 to about 1,
c is from about 0.01 to about 2,
d is from about 0.01 to about 0.5,
e is from about 0.1 to about 2,
f is from 10 to about 50; and
further wherein the fraction of calcium in the total cationic content of the synthesis gel is represented by a charge ratio (RC), wherein RC is described by formula II:
(2x)/(y +z +(2x)) =RC (II);
wherein x represents the number of calcium cations present in the synthesis gel;
y represents the number of potassium cations present in the synthesis gel;
z represents the number of sodium cations present in the synthesis gel; and
RC is between 0 and 1;
aging the synthesis gel;
heating the synthesis gel to produce a product mixture; and
collecting the zeolite from the product mixture.

41. A method of preparing a zeolite comprising:
preparing a synthesis gel, the synthesis gel comprising aNa20:bK20:cCaO:dA1203:eSi02:fH20, wherein a is from about 0.01 to about 5, b is from about 0.01 to about 1, c is from about 0.01 to about 2, d is from about 0.01 to about 0.5, e is from about 0.1 to about 2, f is from 10 to about 50; and
further wherein the fraction of calcium in the total cationic content of the synthesis gel is represented by a charge ratio (RC), wherein RC is described by formula II:
(2x)/(y +z +(2x)) =RC (II);
wherein x represents the number of calcium cations present in the synthesis gel;
y represents the number of potassium cations present in the synthesis gel;
z represents the number of sodium cations present in the synthesis gel; and
RC is between 0 and 1;
aging the synthesis gel;
heating the synthesis gel to produce a product mixture; and
Application No.18/2000875 5 Docket No.: UCH-33401 collecting the zeolite from the product mixture.

42. The method of claim 41, wherein aging the synthesis gel comprises a treatment selected from mechanical agitation, stirring, shaking, swirling, and sonication.

43. The method of claim 41 or 42, wherein aging the synthesis gel does not comprise heating the synthesis gel.

44. The method of claim 41any one of claims 41 43, wherein aging the synthesis gel occurs at about 20-30 ° C. (Currently Amended) The method of claim 41aine-of--elaims-4-1-4-2, wherein heating the synthesis gel comprises heating the synthesis gel to a reaction temperature of from about 350 K to about 410 K. Claims 46-49 (Cancelled) (Currently Amended) The method of claim 41any one of claims 41 to 49, wherein collecting the zeolite from the product mixture comprises washing the zeolite with water, isolating the zeolite by centrifugation, and drying the zeolite.

51. The method of claim 41any one of claims 41 50, wherein RC is from about 0.01 to about 0.99.

52. The method of claim 51, wherein RC is from about 0.1 to about 0.9. Claims 53-91 (Cancelled) Application No.18/2000875 6 Docket No.: UCH-33401

92. A zeolite prepared by the method of claim 41any one of claims 41 94-.
